(19) United States
(12) Patent Application Publication
(10) Pub. No.: US 2004/0158505 A1
(43) Pub. Date: Aug. 12, 2004

(54) Decorating center

(75) Inventors: David P. Kurns, Johnston, IA (US); Paul Krantz, Urbandale, IA (US); Thomas Bonney, Des Moines, IA (US)

Correspondence Address: MCKEE, VOORHEES & SEASE, P.L.C., 801 GRAND AVENUE, SUITE 3200, DES MOINES, IA, 50309-2721, US

(73) Assignee: MEREDITH CORPORATION, Des Moines, IA (US)

(21) Appl. No.: 10/361,706

(22) Filed: Feb. 10, 2003

(51) Int. Cl. G06F 17/60

(52) U.S. Cl. 705/27

(57) ABSTRACT

The present invention relates to providing a website for home decorating content. The invention includes a method of attracting visitors interested in home decorating, including providing a website having (a) a gallery of rooms section having a plurality of room images, each having an associated caption, (b) a project section having a plurality of decorating project descriptions, (c) a member gallery section having a plurality of images of decorated rooms. The method can include providing a means for visitors to become members of the home decorating website, accepting images of decorated rooms from members, and posting the images of the decorated rooms in the member gallery section.

### BACKGROUND OF THE INVENTION

This invention relates to the field of home decorating. More particularly, though not exclusively, this invention relates to a website and related methods for managing home decorating information available to users via a computer network. In particular, the present invention provides an online application that provides ideas, instruction, and inspiration to website visitors with an interest in home decorating.

Home decorating is generally well-known. Also, the provision of decorating content on a website in itself is not new. Various websites have contained content related to home decorating.

One example of such a website is named and provided by iVillage. IVillage includes decorating contents such as articles, photographs, newsletters, message boards, shopping, and advertisements.

Another website is provided by Martha Stewart. The Martha Stewart website includes articles about decorating, photographs accompanying the articles, message boards, shopping that include links to Martha Stewart products and a shopping cart, and advertisements.

Another website is Women.com. This website includes articles about home decorating and photographs accompanying the articles. Other features of the Women.com website include a resource guide listing manufacturers, antique dealers, and stores where merchandise can be obtained, an antiques finder feature, interactive windows such as an interactive tool for designing window treatments, and a style quiz. The site provides for shopping by providing links to resources as well as product reviews and guides. The site also includes advertisements for decorating magazines as well as message boards.

Another example of a website is Homestore.com. The Homestore.com website includes articles on various decorating subjects, most articles having accompanying photos. The website also includes message boards and newsletter signups. The website provides shopping through links and also includes advertisements.

Another website is provided by About. The About website includes articles on home decorating as well as professional photos, that accompany articles. Features of the About website include a free newsletter and a search engine. The About website provides for shopping and includes advertisements.

Another example of a website that provides home decorating content is HGTV. This website includes articles related to decorating as well as professional photographs. One feature of the website is the provision for providing a free newsletter signup. Information on products for purchase is provided on the website. The website also includes advertisements.

Thus, various attempts at providing a website containing home decorating content have been made. These various attempts include different features and combinations of features. Despite these attempts, problems remain.

In particular, what is needed is a home decorating website that provides home decorating content in a manner that encourages users interested in home decorating to visit and revisit the website.

Therefore, it is a primary object, feature, or advantage of the present invention to provide a home decorating website that encourages visitors to visit and revisit the website.

It is a further object, feature or advantage of the present invention to provide a home decorating website that includes meaningful content regarding home decorating that is of interest to visitors.

Another object, feature or advantage of the present invention is to provide a website that allows visitors to the website to contribute to the content of the home decorating website.

As a further object, feature or advantage of the present invention to provide a home decorating website that enhances the ability of a sponsor or advertiser to promote their products or services in a manner that provides meaningful content that is of interest to visitors.

These, and/or other objects, features, and/or advantages of the present invention will become apparent from the Specification and claims that follow.

### SUMMARY OF THE INVENTION

The present invention relates to a website and related methods for attracting visitors interested in home decorating to a home decorating website. According to one aspect of the present invention, the invention provides for providing a website having a gallery of rooms section having a plurality of room images, each of the room images having an associated caption. The website also has a project section having a plurality of decorating project descriptions. The website also includes a member gallery section having a plurality of images of decorated rooms contributed by members. The website allows visitors to become members of the home decorating website. Once visitors become members, they can upload images of decorated rooms to the website. The images are then posted or published in the member gallery section. Thus, the present invention encourages visitors to visit the home decorating website, in part, due to the additional content provided by members. Visitors are also encouraged to revisit the website once they become members, as it provides a vehicle for them to showcase images of their own decorated rooms.

The website can also include a sponsor gallery section having a plurality of images of decorated rooms provided by sponsors. This provides the sponsors with a vehicle to showcase their products in the context of a decorated room in order to increase interest in their products, while at the same time providing meaningful content to visitors of the home decorating website.

According to another aspect of the present invention, a method for providing a home decorating website is provided. The method includes providing a gallery of room sections having a plurality of room images, each of the plurality of room images having an associated caption. The method also includes providing a project and idea section having a plurality of decorating project descriptions, each decorating project description having at least one image and associated instructions. The method also includes providing a decorating lesson section having a plurality of lessons relating to interior design. The method includes providing a member gallery section having a plurality of images of decorated rooms and associated captions. The method further includes providing a means for receiving image uploads for members for the member gallery section, and receiving visits from one or more users. This methodology of the present invention allows a home decorating website to be provided in a manner that encourages users to visit the website and return to the website.

According to another aspect of the present invention, a website for providing home decorating content is provided. The website includes a gallery of room sections comprising a plurality of room images, each of the plurality of room images having an associated caption. The website also includes a project and idea section having a plurality of decorating project descriptions, each decorating project description having at least one image and associated instructions. The home decorating website also includes a decorating lessons section having a plurality of lessons related to interior design. Also the website includes a member gallery section having decorating images and associated captions uploaded by members. In addition, the website can include a sponsor gallery section having decorating images and associated captions uploaded for sponsors. Each of the sections of the website can be displayed and printed by a user.

### BRIEF DESCRIPTION OF THE DRAWINGS

FIG. 1 is a representation of a web page associated with the present invention showing home decorating content.

FIG. 2 is a representation of a web page of the website according to the present invention showing decorating content.

FIG. 3 is a web page from a website according to one embodiment of the present invention as showing home decorating content.

FIG. 4 is a representative web page from a website according to one embodiment of the present invention.

FIG. 5 is a flow diagram showing steps taken by a member to contribute home decorating content to a website.

FIG. 6 is a representative web page showing content provided by a member of the website or a sponsor of the website.

FIG. 7 is an organizational chart showing one structure of a website according to a preferred embodiment of the present invention.

### DETAILED DESCRIPTION OF THE PREFERRED EMBODIMENT

The present invention provides for a website for providing home decorating content. The website preferably provides meaningful content related to home decorating in order to attract visitors to the website. In addition, the website allows users of the website to become members of the website and then contribute additional home decorating content. This serves to encourage members to return to the website. Also, the present invention allows sponsors to contribute to the website such that sponsors are contributing meaningful information regarding home decorating.

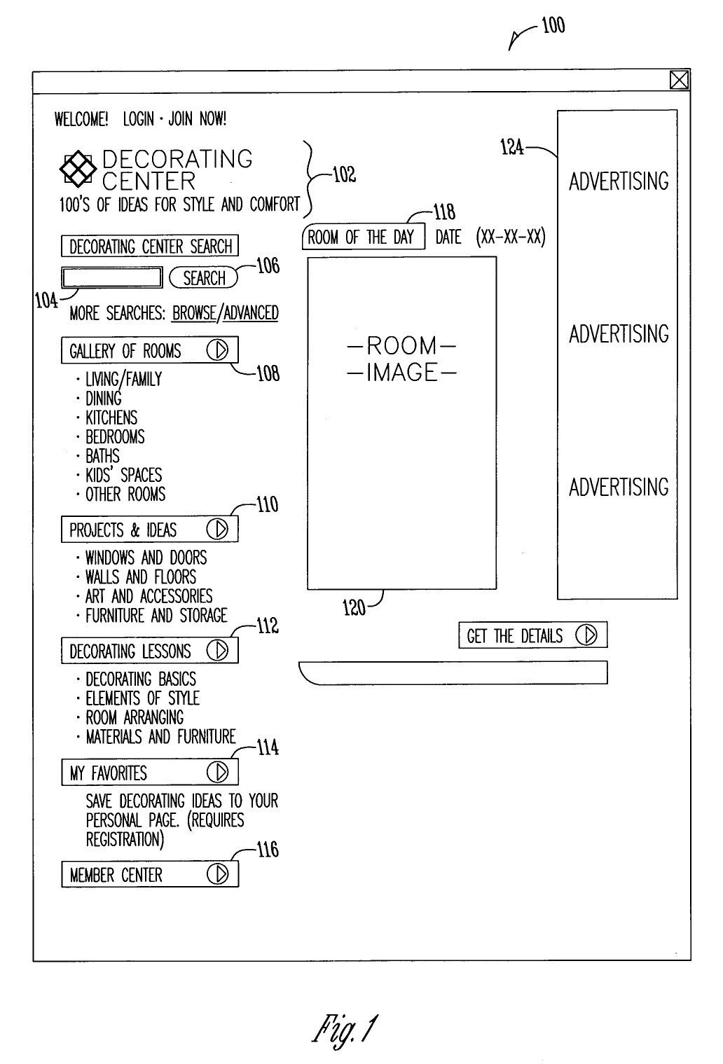

In FIG. 1, a web page 100 is shown. In web page 100, a title 102 is shown for the website indicating that the website provides home decorating content.

The website also includes a mechanism for searching a website. An input box 104 is shown that allows a user to enter a word or phrase to locate. A search button 106 is shown that a user can select to initiate a search. The website 100 includes various sections and provides for navigation in and among those sections. The gallery of room section 108 provides a collection of room images with detailed captions. Content in this section is preferably designed to illustrate how the principles of good decorating can be combined to provide a pleasing overall look and feel to a room. The types of rooms can be categorized. For example the types of rooms can be categorized into living/family rooms, dining rooms, kitchens, bedrooms, baths, kids spaces, and other rooms. The present invention is in no way limited to the particular categorization of rooms.

A project and ideas section 110 is shown. The project and ideas section can include a collection of decorating projects that are preferably simple. Each project can include one or more images plus the information and instructions needed to reproduce the project. The project can be categorized in various ways. For example, in one embodiment the projects and ideas can be categorized into windows and doors, walls and floors, art and accessories, and furniture and storage.

A decorating lessons section 112 is also shown. The decorating lesson section is preferably a collection of short articles, each of which provides a lesson on the essential skills, concepts, and principles that form the foundation of good interior design. The lessons can include decorating basics, elements of style, room arranging, materials and furniture, or the lesson can be directed towards other aspects of good interior design.

A “my favorites” section 114 is also provided. The “my favorites” section 114 allows a registered user (member) to save decorating ideas such as a list of user-selected articles. Thus, the member can return to the home decorating website and easily access those articles that they have previously expressed interest in.

A member center 116 provides information and features available only to registered users.

The main page 100 can include a title for a room of the day 118 with an accompanying room image 120. In addition, the main page 100 can include advertising such as an advertising image or a banner 124.

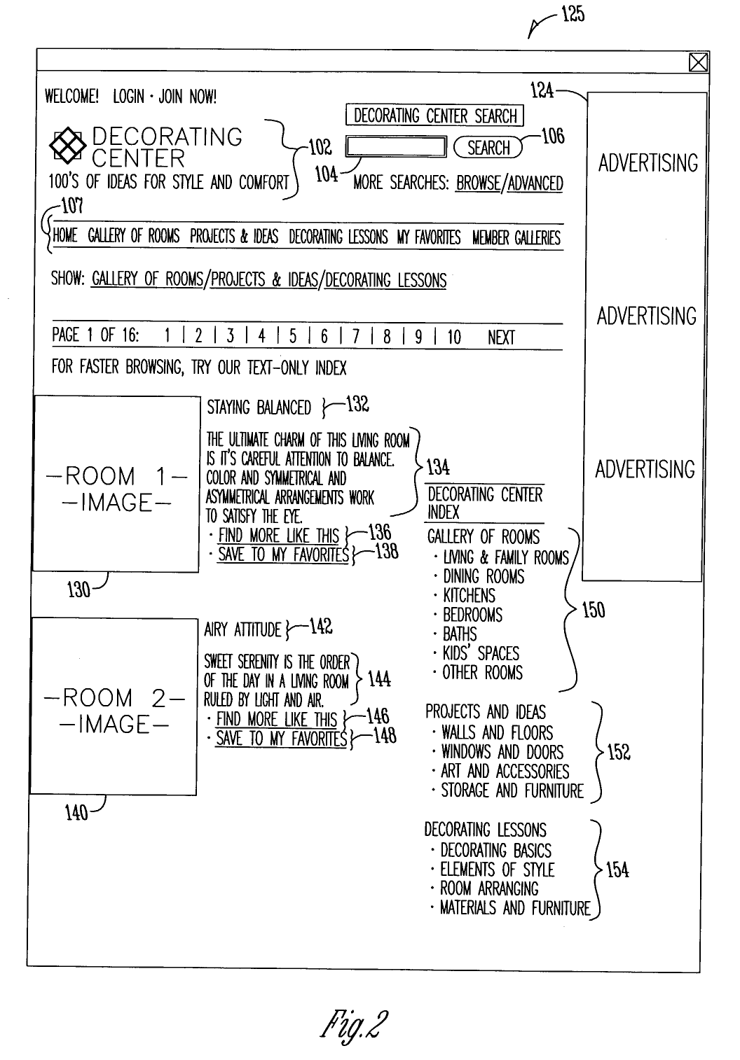

FIG. 2 illustrates a web page 125 associated with decorating lessons. Each decorating lesson can include an image, such as a room image 130. In addition, there can be a caption 132 associated with the decorating lesson as well as a description 134. Users are allowed to select the link “find more like this” 136 to find other decorating lessons with the same or similar key words. Users are also allowed to select link “save to my favorites” 138 to save a link to this lesson to their favorites page if the user is a registered user or member.

Also, a synopsis of a second decorating lesson is shown with an image 140, a caption 142 for the image and a description 144 for the image. The user is also allowed to select “find more like this” 146 or “save to my favorites” 148 associated with the second lesson.

Also shown in the web page 125 is a decorating center index that provides an index of the gallery of rooms section 150, the projects and ideas section 152, and the decorating lessons section 154.

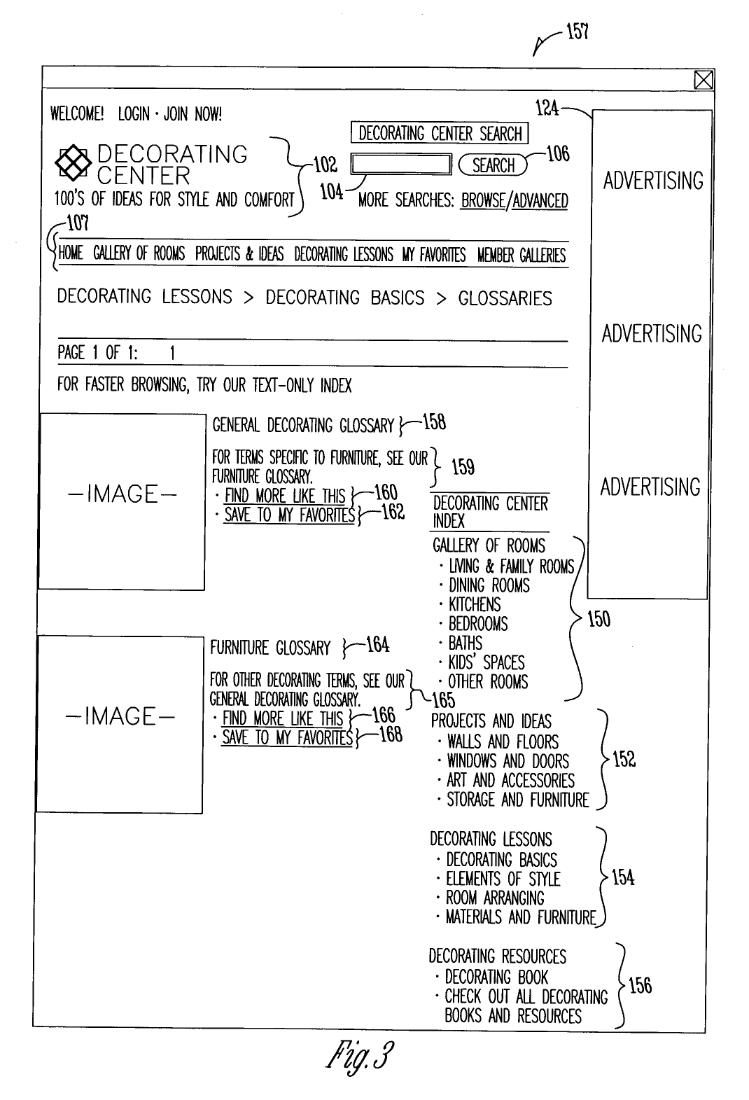

FIG. 3 provides a web page 157 associated with decorating lessons. In web page 157, a link to a “general decorating glossary” 158 is shown. In addition, there is a description 159. Also, there are links for “find more like this” 160 and “save to my favorites” 162.

A second decorating lesson relating to a furniture glossary is also shown. There is a title “furniture glossary” 164, a short description 165, and links to “find more like this” 166 and “save to my favorites” 168.

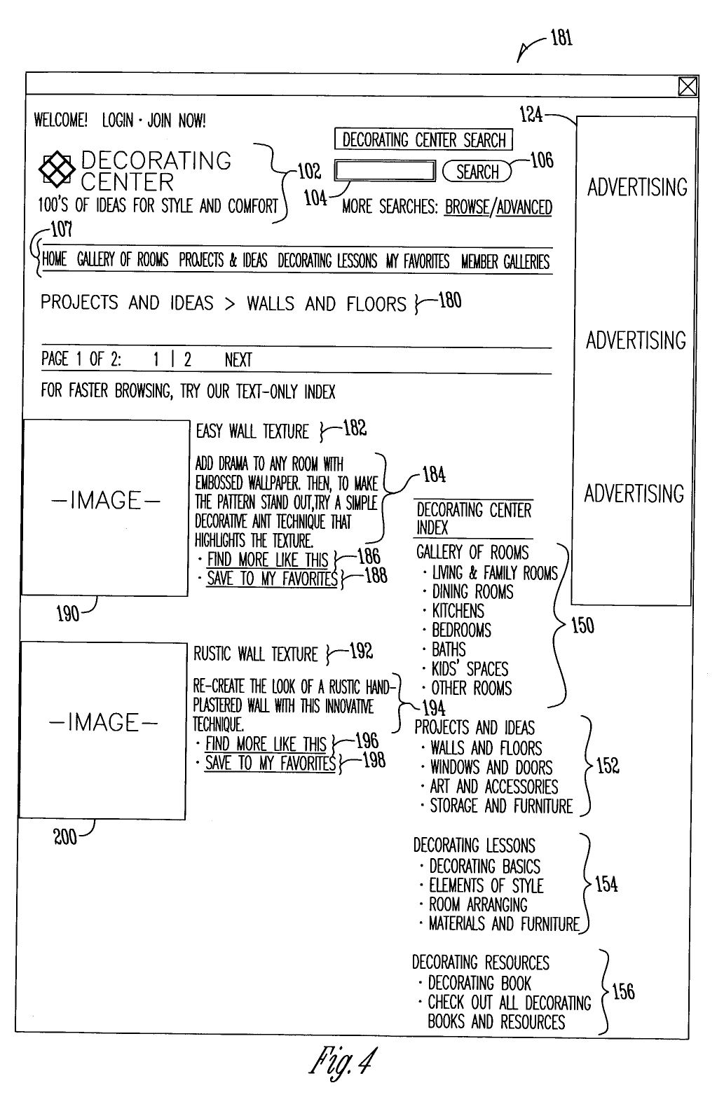

FIG. 4 provides a web page 181 associated with providing content for projects and ideas, specifically walls and floors. There is a navigation description 180 indicating the location of the web page 181 within the context of the website.

In addition, there is information concerning projects and ideas. A first project for adding easy wall texture is shown. There is a title 182, description 184 associated with an image 190 for the project. In addition, there are links for “find more like this” 186 and “save to my favorites” 188.

A second project is shown. There is a title 192 associated with a description or caption 194, a link for “find more like this” 196 and “save to my favorites” 198 as well as an associated image 200.

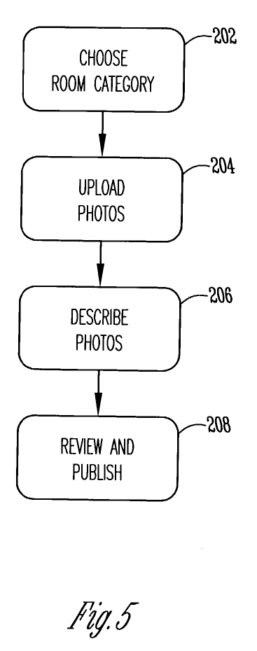

FIG. 5 provides a flow diagram of the methodology used by a registered user or member to add content to the website. In step 202, the member would “choose room category”. Examples of room categories might include living rooms, bedrooms, dining rooms, kitchens, kids rooms, and/or any other description used to categorize a room. Once the member selects a room category in step 202, the member can then upload photos in step 204. Members provide the opportunity to describes the photos in step 206 as well as to review and publish the photos in step 208.

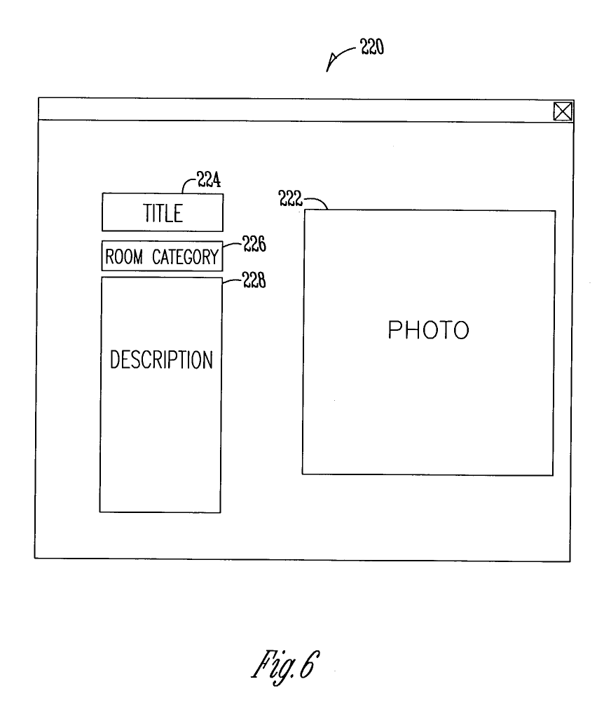

FIG. 6 provides an illustration of a web page 220 that can be a part of a member gallery or sponsor gallery. In web page 220, a title 224 is shown. In addition, a room category 226 is shown. Also, a description of the room 228 provided by the member or sponsor is also shown. A photo 222 accompanies the title, room category, and description. This information is also provided by the member or sponsor. Thus, the present invention provides for members or sponsors to add to the decorating content of the website by providing information about a room.

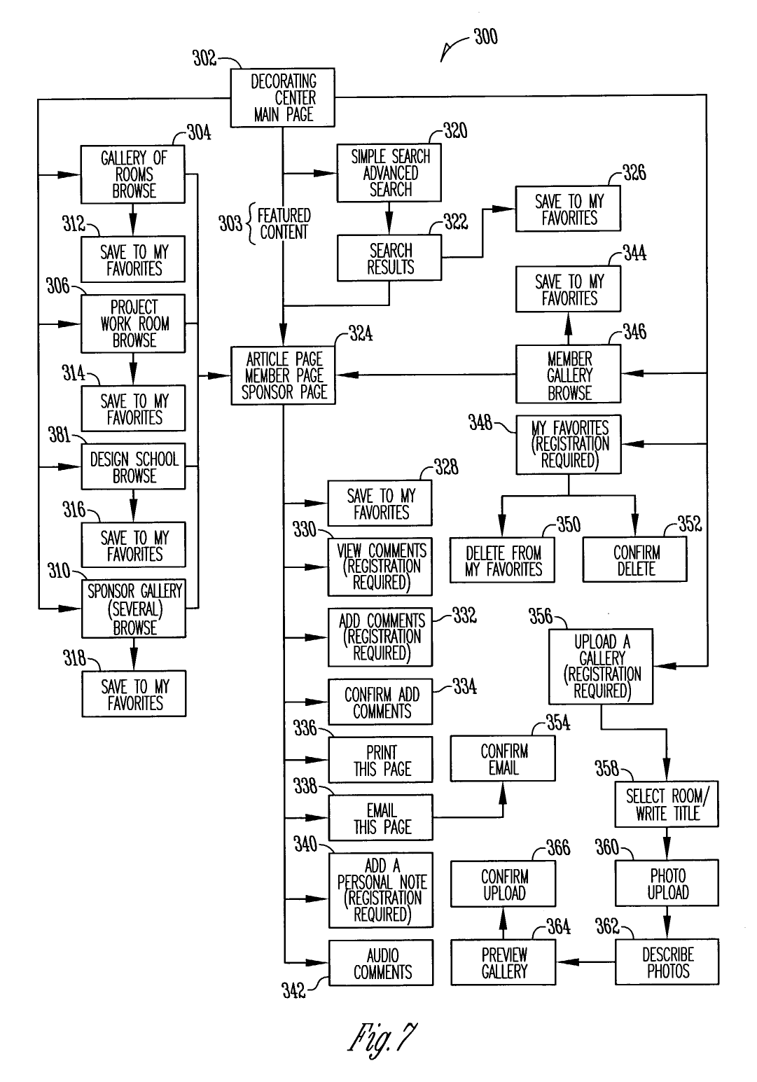

FIG. 7 illustrates the structure of one embodiment of a website according to the present invention. The organization or structure 300 includes a decorating center main page 302. The decorating center main page 302 is the opening page for the application. In the preferred embodiment, the decorating center main page includes a number of key elements. One key element is featured content 303. This module can include manually generated links to articles in the gallery of rooms section. The featured content 303 can include a photo and introduction. If not randomly selected, editors can manually select content if they choose. Another key element is the gallery of rooms 304. This module can include links to index pages associated with the sub categories of the gallery of rooms. It can also include a link to the index page for the entire section.

The project and ideas element 306 can include links to index pages associated with the subject categories of the project work room. It can also include a link to the index page for the entire section.

The decorating lessons or design school can include links to index pages associated with the categories of the design school. It can also include a link to the index page for the entire section.

A member gallery 346 can provide links to the index pages associated with sub-categories of the member gallery. It can also include a link to the index page for the entire section. The “save to my favorites” option 344 can be selected to save member pages to my favorites section.

The sponsor gallery section 310 can include a link to the index page of sponsored article collections.

In addition, the main page 302 can include other links to pages where you just can browse sections or search via keywords. In addition, the decorating center main page can include links to the member's list of saved decorating center articles.

The decorating center main page 302 can also include links for uploading a room 356. This links to forms that allow a registered member to upload and categorize photos and text. This includes allowing a registered user or member to select a type of room and write a title 358, upload a photo 360, describe the photo 362, preview the gallery listing 364, and confirm the upload 366.

With any page, the visitor or member has various options. These options include “save to my favorites” 328, “view comments” 330, “add comments” 332, “confirm add comments” 334, “print this page” 336, “Email this page” 338 and then “confirm Email” 354, “add a personal note” 340, and “audio comments.”

The “my favorites” section 348 also allows a member to “delete from my favorites” 350 and then “confirm delete” 352.

Also available from the decorating center main page 302 are options for “search” 320. “Search results” 322 are available and these can be saved to “my favorites” 326.

Thus, a website and related methods associated with home decorating has been disclosed. The present invention contemplates variation in the specific content, types of rooms, manner of registration process and other insubstantial differences within the spirit and scope of the claimed invention.

What is claimed is:

1. A method of attracting visitors interested in home decorating to a home decorating website, comprising:
providing a website having (a) a gallery of rooms section having a plurality of room images, each having an associated caption, (b) a project section having a plurality of decorating project descriptions, (c) a member gallery section having a plurality of images of decorated rooms;
providing a means for visitors to become members of the home decorating website;
accepting images of decorated rooms from members; and
posting the images of the decorated rooms in the member gallery section.

2. The method of claim 1 further comprising providing a decorating lesson section having a plurality of lessons related to interior design.

3. The method of claim 1 wherein the step of providing a means for visitors to become members includes providing a registration process for users.

4. The method of claim 1 further comprising displaying advertising associated with home decorating on the website.

5. The method of claim 1 further comprising providing a sponsor gallery section having a plurality of images of decorated rooms provided by sponsors.

6. The method of claim 1 wherein the advertising includes inventory for home decorating print publications.

7. The method of claim 1 wherein the decorating rooms are selected from the set comprising living rooms, family rooms, dining rooms, kitchens, bedrooms, baths and kid spaces.

8. The method of claim 1 further comprising allowing members to save favorites.

9. The method of claim 1 further comprising receiving a search request from a user.

10. A method for providing a home decorating website, comprising:
providing a gallery of rooms section having a plurality of room images, each of the plurality of room images having an associated caption;
providing a project and ideas section having a plurality of decorating project descriptions, each decorating project description having at least one image and associated instructions;
providing a decorating lesson section having a plurality of lessons related to interior design;
providing a member gallery section having a plurality of images of decorated rooms and associated captions;
providing a means for receiving image uploads from members for the member gallery section; and
receiving visits from one or more users.

11. The method of claim 10 further comprising providing a means for the one or more users to become members.

12. The method of claim 11 wherein the means for the one or more users to become members include a registration process.

13. The method of claim 10 further comprising displaying advertising associated with home decorating.

14. The method of claim 13 wherein the advertising includes advertising for home decorating print publications.

15. The method of claim 10 wherein the decorated rooms are selected from the set comprising living rooms, family rooms, dining rooms, kitchens, bedrooms, baths, and children's spaces.

16. The method of claim 11 further comprising providing a means for members to save favorites.

17. A website for providing home decorating content to be used over a computer network, comprising:
a gallery of rooms section comprising a plurality of room images, each of the plurality of room images having an associated caption;
a project and ideas section comprising a plurality of decorating project descriptions, each decorating project description comprising at least one image and associated instructions;
a decorating lessons section comprising a plurality of lessons related to interior design;
a member gallery section comprising decorating images and associated captions uploaded by members;
a sponsor gallery section comprising decorating images and associated captions uploaded for sponsors; and
each of the sections displayable and printable by the user.
